(19) United States
(12) Patent Application Publication
(10) Pub. No.: US 2012/0260408 A1
(43) Pub. Date: Oct. 18, 2012

(54) BARRIER PAPER AND BARRIER CLOTHING USING SAME

(75) Inventor: Kwang Yun Hwang, Toronto (CA)

(73) Assignee: UPC.,LTD., Nonsan-si, Chungcheongnam-do (KR)

(21) Appl. No.: 13/518,760

(22) PCT Filed: Mar. 23, 2010
(86) PCT No.: PCT/KR2010/001779

§ 371 Date: Jun. 22, 2012

(30) Foreign Application Priority Data
Dec. 22, 2009 (KR) 10-2009-0128756

(51) Int. Cl. B32B 27/08; A62B 17/00; B32B 27/06

(52) U.S. Cl. 2/455; 428/523; 428/474.4; 428/522

(57) ABSTRACT

The present invention relates to barrier paper and barrier clothing using the same, and can be used at a workplace, CBR warfare or the like in a harmful environment by remarkably obstructing gas and solvents such as toluene, nitrobenzene, chlorine gas, acetone and the like which are harmful to the human body.

### TECHNICAL FIELD

(1) The present invention relates to a barrier laminated paper and barrier clothing using the same.

### BACKGROUND ART

(2) Lots of harmful gases injurious to the humane body are emitted at semiconductor production sites, factories using toxic organic solvent etc. In recent, a plurality of accidents assumed to be industrial disaster have occurred in a certain semiconductor company an d tire company etc., and the number of employees who have died of cancer is continuously increased, which becomes a social problem.

(3) In such a situation, urgently required is the need to produce work clothing by using material able to obstruct gas and liquid harmful to the human body.

(4) A breathable barrier laminated paper disclosed in Korean Patent No. 411835 of the applicant obstructs permeation of water, but allows free permeation of gas, therefore, has a problem that it cannot obstruct gas in the environment where harmful gas is generated.

### DISCLOSURE OF THE INVENTION

(5) An object of the present invention is to provide a barrier laminated paper having improved barrier property with respect to harmful gas and harmful solvent etc., and barrier clothing using such a barrier laminated paper.

(6) For achieving the object, the inventor have produced a barrier laminated paper able to obstruct various harmful gas and harmful solvent by laminating barrier film with breathable laminate d paper conventionally used for producing breathable work clothing, and also produced barrier clothing by using the barrier laminated paper.

(7) The inventor used barrier resin having hydrophilic group such as polyamide, ethylene vinyl alcohol copolymer(EVOH) a s outermost layer and multilayer co-extruded barrier film containing polyolefin based resin as innermost layer and laminated the barrier resin and film with the breathable laminated paper, whereby it was recognized that obstruction rate for harmful gas and harmful solvent such as acetone, toluene, chlorine gas etc. other than oxygen could be remarkably increased, thus the present invention has been completed.

(8) The barrier laminated paper of the present invention remarkably obstructed the gas and liquid harmful to the human body such as toluene, nitrobenzene, chlorine gas, acetone etc.

(9) The barrier laminated paper of the present invention comprises:
a breathable film formed by resin composition comprising 30˜70 wt. % of polyolefin based resin, 1˜70 wt. % of alpha olefin copolymer and 20˜70 wt. % of inorganic filler;

(10) A multilayer co-extruded barrier film comprising barrier resin having hydrophilic group such as polyamide, ethylenevinyl alcohol copolymer(EVOH) as outermost layer and polyolefin as innermost layer;

(11) Adhesive applied between the breathable film and multilayer co-extruded barrier film;

(12) Polypropylene based reinforcing material adhering to one side surface of the breathable film; and

(13) Adhesive applied between the breathable film and reinforcing material.

(14) Furthermore, the barrier laminated paper of the present invention may comprise polypropylene based reinforcing material adhering to one side surface of the multilayer co-extruded barrier film which is not subjected to adhesion; and adhesive applied between the multilayer co-extruded barrier film and polypropylene based reinforcing material.

(15) The polyolefin based resin constituting the breathable film may be selected from ethylene-alpha-olefin copolymer re sin, low-density polyethylene resin, alpha-olefin copolymer or copolymer resin. For example, if the density of the ethylene-alpha-olefin copolymer resin is lower than 0.865, melt viscosity is increased in ex trusion process, thereby elevating extrusion load, thus processabilty and breathability are lowered, and if the density is higher than 0.950, impact strength of the film is lowered and surface of the film is roughened, thus the quality of product is lowered and application is limited, therefore, the density is preferably selected at least in the range from 0.865 to 0.950. Here, melt index is 1 to 10. As alpha-olefin of the ethylene-alpha-olefin copolymer resin, butene, hexane, octane, octane based metallocene etc. may be used, and in particular, for reducing and effectively distributing the extrusion load, the polyolefin based resin is preferably used in powder state rather than pellet state. Then, the density of low-density polyethylene is 0.900 to 0.930, the melt index thereof is preferably 1.0 to 10.0, more preferably, 3.0 to 7.5. Furthermore, the density of the alpha-olefin copolymer is 0.890 to 0.930, and the melt index thereof is preferably 2.0 to 5.0.

(16) Meanwhile, in blending of the polyolefin base d resin, if the content of the low-density ethylene is increased, extrusion processability of the breathable film is enhanced, but physical strength thereof is lowered, and in particular, tensile strength and tearing strength are lowered, therefore, the content of the low-density ethylene has to be increased within limited range. Furthermore, if the content of the alpha-olefin copolymer is increased to a certain amount, dispersion effect of the inorganic filler and pinhole phenomenon due to the inorganic filler can be effectively improved, and in particular, reactivity with reactive polyurethane based adhesive applied in laminating process of the present invention is enhanced, thus adhesive strength is enhanced, and as a result, it is appreciated that a firmly adhered state can be kept even at the time of washing such as water laundry and dry cleaning, as described below.

(17) Furthermore, if the polyolefin based resin is added in a proper amount, the surface of the breathable film is very soft and smooth, and a product can be formed which is excellent in flexibility and therefore resistance to impact from the outside.

(18)

(19) Meanwhile, it is preferred that the alpha-ole fin copolymer used for the breathable film for production of the laminated paper of the present invention has softening point of 60° C. or more and its melt index is 1.0 to 5.0 and its density is 0.880 to 0.920. Such set range of each property is a necessary condition for well dispersing olefin based resins of different properties into each other and thus melting them without phase separation. For example, it was shown that if the softening point of the olefin is excessively high, the dispersion may be affected, and if the melt index and density deviate from the above-mentioned ranges, essential requirements for the breathable film such as breathability, tensile strength, impact strength, tearing strength etc. of the film may be badly affected.

(20) Subsequently, one or both of the surfaces of the breathable film may be selectively subjected to corona discharge treatment or plasma treatment in in-line state in order to enhance printability or adhesiveness of the finished breathable film.

(21) Meanwhile, when producing the breathable film, various components such as resin additive may be included according to application of the film. Furthermore, phenol based or phosphor based antioxidant, process stabilizer or activator such as zinc stearate, calcium stearate and metal salt stearate may be included. For example, ultraviolet stabilizer, heat stabilizer etc. as antioxidant is preferably added to the breathable film applied to industrial clothing, hair or simulation packaging material, house wrap or roofing material for preventing dew condensation on buildings, and laminated paper product for use in fruit trees. Furthermore, anti-static agent, flame retardant, antioxidant etc. is preferably added to the industrial clothing in a certain case.

(22) As barrier resin having hydrophilic group in the multilayer co-extruded barrier film of the present invention, there are polyamide or ethylene-vinyl alcohol copolymer etc., and specific ally, copolymer of ethylene-vinyl alcohol resulting from saponification of ethylene-vinyl acetate produced by copolymerization of polyamide(f or example, ployamide-6, ployamide-6/66, ployamide-12 or ployamide-6/12) and ethylene and vinyl acetate, or EVOH obtained by mixing them may be used. The polyamide is preferably used in the amount of 5 to 95 wt. %. It is preferred that degree of saponification of EVOH exceeds 95%, and if the degree of saponification of EVOH is not higher than 95%, oxygen barrier property is not sufficient, and the higher degree of saponification results in excellent oxygen barrier property.

(23) As polyolefin which can be used in the multilayer co-extruded barrier film of the present invention, there are polyethylene, polypropylene or ethylene based copolymer etc., and in particular, mentioned as example thereof may be linear low-density polyethylene (LLDPE), low-density polyethylene (LDPE) or high-density polyethylene (HDPE), ethylene-vinyl acetate copolymer and ethylene-alkyl (meth)acrylate copolymer, ethylene-(meth)acrylic acid copolymer and metal salt(ionomer) of ethylene-(meth)acrylic acid copolymer, polypropylene etc., and mixture of one or more of them is used.

(24) Meanwhile, also when producing the multilayer co-extruded barrier film, various components such as resin additive may be included in a range which does not affect original function of the barrier film, gas and liquid barrier property according to application of the film. Furthermore, phenol based or phosphor based antioxidant, process stabilizer or activator such as zinc stearate, calcium stearate and metal salt stearate may be included. For example, ultraviolet stabilizer, heat stabilizer etc. as antioxidant is preferably added to the breathable film applied to industrial clothing, hair or simulation packaging material, house wrap or roofing material for preventing dew condensation on buildings, and laminated paper product for use in fruit trees. Furthermore, anti-static agent, flame retardant, antioxidant etc. is preferably added to the industrial clothing in a certain case.

(25) The construction of the multilayer co-extruded barrier film of the present invention is not particularly limited, but the film is usually formed by 3 to 6 layers. Various multilayer films are possible having a layer construction such as A/B/E, A/B/E/E, A/A/B/E, A/A/B/E/E, A/B/A/B/E, A/B/C/B/E, A/C/B/E, A/C/B/E/E/, A/B/E/B/A/B/E, A/B/A/C/A/B/E, C/B/E, C/B/A/B/E etc., where A is barrier resin having hydrophilic group, B is adhesive resin, C is EVOH, and E is polyolefin based resin.

### MODES FOR CARRYING OUT THE INVENTION

(26) Hereinafter, the construction of the present invention will be described in more detail through examples. However, it is obvious to persons having ordinary skill in the technical field to which the present invention belongs that the scope of the present invention is not limited by the following examples.

(27)

### (28) EXAMPLE 1

### Production of Breathable Film

(29) Resin composition comprising 40 wt. % of powdered ethylene-alpha-olefin copolymer resin with the density of 0.90 and melt index of 5; 30 wt. % of alpha-olefin copolymer with the density of 0.90 and melt index of 3.0; and 40 wt. % of inorganic filler was extruded by single screw extruder and subjected to casting process through die by casting rollers, and thereafter was cooled and then formed into sheet-like breathable film.

(30)

### (31) EXAMPLE 2

### Production of Multilayer Co-extruded Barrier Film

(32) Polyamide/polyamide/adhesive resin/polyethylene is charged into each extruder of 4-layer film producing apparatus having extruders different from each other, and film was formed in circular die for co-extrusion and then passed through pulling rollers to be formed into a two-ply flat film having a width of 1,000 mm, and subsequently the flat film was passed through curl removing apparatus disclosed in Korean Patent No. 815605. At this time, polyamide-6 having intrinsic viscosity of 4.0 was used as polyamide and maleic anhydride modified polyethylene having melt viscosity of 2.0(190° C., 10 kg) was used as adhesive resin, and linear low-density polyethylene (LLDPE) having melt viscosity of 1.0 was used as polyethylene. Total film thickness was 80 pm wherein the thickness of each layer was 10/10/10/50 μm. At this time, the curl removing apparatus comprises water tank having an inlet pipe for introducing hot water of 50° C.˜98° C. and an outlet pipe for discharging the hot water; a plurality of guide rolls installed inside and outside the water tank and contacting with the co-extruded multilayer film to guide advance course thereof; first and second driving rolls each mechanically connected with two guide rolls installed within the water tank to transfer driving power of rotation motor to the guide rolls; at least a pair of squeeze rolls for squeezing and dehydrating both surfaces of the co-extruded multilayer film which has passed through the water tank; drying apparatus installed downstream of the squeeze rolls and blowing hot air to both surfaces of the co-extruded multilayer film which has passed through the squeeze rolls; and winding roll for winding the co-extruded multilayer film which has passed through the drying apparatus. At this time, the temperature of water within the water tank was kept at 90° C. and water passing time of the film was 3.7 seconds. The passed films was each divided to one-ply film and thereafter was wound into film roll state.

(33)

### (34) EXAMPLE 3

### Production of Barrier Laminated Paper

(35) The breathable film produced as in the example 1 is introduced into adhesive application apparatus, where the adhesive is applied to both side surfaces of the film by application rollers. The breathable film with the adhesive applied thereon is dried to a certain level while being fed within the drying chamber, and thereafter, the multilayer co-extruded barrier film produced as in the example 2 and polypropylene nonwoven fabric as polypropylene based reinforcing material are each fed to the laminating apparatus to be supplied to both side surfaces of the breathable film, and are squeezed by compression rollers to thereby be adhered and laminated.

(36) In this way, adhesive is present between the multilayer co-extruded barrier film and breathable film and between the breathable film and layer of reinforcing material, respectively, whereby the barrier laminated paper according to an example of the present invention is produced.

(37)

### (38) EXAMPLE 4

### Production of Barrier Laminated Paper

(39) Adhesive is applied by the application rollers to the multilayer co-extruded barrier film side of the barrier lamina ted paper produced as in the example 3 and thereafter the barrier laminated paper is fed into the drying chamber to be dried to a certain level, and subsequently, polypropylene nonwoven fabric as polypropylene base d reinforcing material is fed to the laminating apparatus and then squeezed with the multilayer co-extruded barrier film surface of the barrier laminated paper of the example 3 by compression rollers to thereby be adhered and laminated.

(40) In this way, the polypropylene based reinforcing material is present on outermost layer and the breathable film and multilayer co-extruded barrier film are present inside the polypropylene based reinforcing material, and adhesive is present between two layers of reinforcing material and between two layers of films, respectively, whereby barrier laminated paper according to another example of the present invention is produced.

(41)

### (42) EXAMPLE 5

### Production of Work Clothing Utilizing the Barrier Laminated Paper

(43) Upper part and lower part of the work clothing is separately and dividedly produced utilizing the barrier laminated paper of the example 4, and for the upper and lower parts, sleeves and longitudinal parts are formed according to the body size of a worker, and zippers are attached over lower ends of the sleeves and longitudinal parts, respectively, whereby the work clothing is produced in which the lower ends of the sleeves and longitudinal parts can be each releasably attached.

(44)

### (45) Comparative Example

### Barrier Laminated Paper of Another Company

(46) As a comparative example, S product was selected which was obtained by laminating special barrier film of D company and nonwoven fabric.

(47)

(48)

TABLE 1

| | | Comparative Example | | | Exa [symbol] ple | | |
|---|---|---|---|---|---|---|---|
| | | | Breakthrough | [symbol] ermeation | | Breakthrough | [symbol] ermeation |
| | Physical | Concentration | Normalized | Rate | Concentration | Normalized | Rate |
| chemical [symbol] | Phase | (%) | (Min) | ( [symbol] /min) | ( [symbol] ) | (Min) | [symbol] |
| Acetone | L | 95 [symbol] | [symbol] diate | 7.85 | 99.5 | >4 [symbol] 0 | ND |
| Ace [symbol] onitrile | L | 95 [symbol] | 68 | 0.2 | 99.5 | >4 [symbol] 0 | ND |
| 1,3-Butedlene | G | 95 [symbol] | >4 [symbol] 0 | <0.02 | 99.5 | >4 [symbol] 0 | ND |
| Carbon Disulfide | L | 95 [symbol] | [symbol] diate | >50 | 99.9 | >4 [symbol] 0 | ND |
| Chlorine Gas | G | 95 [symbol] | >4 [symbol] 0 | <0.01 | 99.5 | >4 [symbol] 0 | ND |
| Dichlor [symbol] nethane | L | 95 [symbol] | [symbol] ediate | >50 | 99. [symbol] | >4 [symbol] 0 | ND |
| Dieth [symbol] lanine | L | 9 [symbol] | 12 | >50 | 99.5 | 7 | 1.05 |
| N, [symbol] -Di [symbol] ethylfo [symbol] anide | L | 95 [symbol] | 78 | 0.40 | 99. [symbol] | >4 [symbol] 0 | ND |
| Ethyl Acetate | L | 95 [symbol] | Im [symbol] ediate | 6.3 | 99.8 | >4 [symbol] 0 | ND |
| Ethylene Oxide | G | 95 [symbol] | [symbol] diate | 6.4 | 99.5 | >4 [symbol] 0 | ND |
| n-Hexane | L | 95 [symbol] | [symbol] ediate | 99 | 99.0 | >4 [symbol] 0 | ND |
| Methyl Chloride | G | 95 [symbol] | >4 [symbol] 0 | <0.006 | 99.5 | >480 | ND |
| Nitro [symbol] enzene | L | 95 [symbol] | 102 | 2.3 | 99.0 | >4 [symbol] 0 | ND |
| Sodi [symbol] | L | 50 | >480 | <0.1 | 50.0 | >4 [symbol] 0 | ND |
| [symbol] roxide.50% | | | | | | | |
| Sulfuric Acid(conc.) | L | 95 [symbol] | >480 | ND | 95.0-98.0 | >4 [symbol] 0 | ND |
| Tetrachlor [symbol] ethylene | L | 95 [symbol] | Im [symbol] ediate | 5.7 | 99.9 | >480 | ND |
| Tetrat [symbol] rofuran | L | 95 [symbol] | Im [symbol] ediate | >50 | 99.9 | >4 [symbol] 0 | 0.050 |
| Toluene | L | 95 [symbol] | Im [symbol] ediate | 25 | 99. [symbol] | >4 [symbol] 0 | ND |

[symbol]

indicates data missing or illegible when filed

### (49) Experimental Example

### Test for Liquid and Gas Permeability

(50) For the barrier laminated paper of the example 3 and barrier laminated paper of the comparative example, test was performed for permeability. with respect to acetone, acetonitrile, 1,3-butadiene, carbon disulfide, chlorine gas, dichloromethane, diethylamine, N, N-dimethylformamide, ethyl acetate, ethylene oxide, n-hexane, methyl chloride, nitrobenzene, sodium hydroxide(50%), tetrachloroethylene, tetrahydrofuran and toluene according to ASTM F 739 (Standard Test Method for Permeation of Liquids and Gases through Protective Clothing Materials under Conditions of Continuous Contact).

(51) As shown in Table 1, the result is that the barrier laminated paper of the present invention did not exhibit permeability with respect to almost all harmful gas and liquid as object to be tested.

(52)

(53) The barrier laminated paper of the present invention can be utilized for work clothing for workplaces of harmful environment and also variously utilized for combat uniforms for CBR warf are etc.

What is claimed:

1. A barrier laminated paper comprising:
a breathable film formed by resin composition comprising 30˜70 wt. % of polyolefin based resin, 1˜70 wt. % of alpha olefin copolymer and 20˜70 wt. % of inorganic filler;
a multilayer co-extruded barrier film comprising barrier resin having hydrophilic group as outermost layer and polyolefin as innermost layer;
adhesive applied between the breathable film and multilayer co-extruded barrier film;
polypropylene based reinforcing material adhering to one side surface of the breathable film; and
adhesive applied between the breathable film and reinforcing material.

2. The barrier laminated paper according to claim 1, further comprising polypropylene based reinforcing material adhering to one side surface of the multilayer co-extruded barrier film which is not subjected to adhesion; and adhesive applied between the multilayer co-extruded barrier film and polypropylene based reinforcing material.

3. The barrier laminated paper according to claim 1, wherein the barrier resin having hydrophilic group is at least one of polyamide and ethylene-vinyl alcohol copolymer(EVOH).

4. The barrier laminated paper according to claim 1, wherein the polyolefin is at least one selected from linear low-density polyethylene (LLDPE), low-density polyethylene (LDPE), high-density polyethylene (HDPE), ethylene-vinyl acetate copolymer, ethylene-alkyl (meth)acrylate copolymer, ethylene-(meth)acrylic acid copolymer, metal salt(ionomer) of ethylene-(meth)acrylic acid copolymer and polypropylene.

5. Barrier clothing produced using the barrier laminated paper according to claim 1.

6. Barrier clothing produced using the barrier laminated paper according to claim 2.

7. Barrier clothing produced using the barrier laminated paper according to claim 3.

8. Barrier clothing produced using the barrier laminated paper according to claim 4.
